(19) United States
(12) Patent Application Publication
(10) Pub. No.: US 2026/0002452 A1
(43) Pub. Date: Jan. 1, 2026

(54) CORE GAS PATH BOUNDARY STRUCTURE FOR GAS TURBINE ENGINE

(71) Applicant: Pratt & Whitney Canada Corp., Longueuil, Quebec (CA)

(72) Inventors: Philippe Boyer, Saint Isidore (CA); Jocelyn Bisson, Saint-Basile-Le-Grand (CA); Jasrobin Grewal, Pincourt (CA)

(21) Appl. No.: 18/758,872

(22) Filed: Jun. 28, 2024

(51) Int. Cl. F01D 25/24

(52) U.S. Cl. CPC F01D 25/24; F05D 2240/126; F05D 2240/14

(57) ABSTRACT

A core gas path boundary structure is provided that includes an annular housing panel and a baffle. The annular housing panel has a first end segment and a second end segment. The first end segment of the housing panel (HPFES) has an HPFES outer radial surface and a HPFES support rail extending radially outward from the HPFES outer radial surface. The baffle has a body and a first stiffening ring. The body has a baffle first end segment and a baffle second end segment. The first stiffening ring is attached to an inner radial surface of the baffle first end segment. The first stiffening ring has an edge surface. The baffle is engaged with the annular housing panel such that the baffle first end segment is in contact with the HPFES support rail. The edge surface of the first stiffening ring is radially aligned with the HPFES support rail.

### BACKGROUND OF THE INVENTION

### 1. Technical Field

The present disclosure relates to gas turbine engines in general and to core gas path boundary structures utilized within gas turbine engines in particular.

### 2. Background Information

Turbine engines include components core gas path boundary structures that are subject to extreme temperatures. Such components are often subject to wear over time. The wear can necessitate repair and/or replacement. It would be desirous to improve the useful life of such components.

### SUMMARY

According to an aspect of the present disclosure, a core gas path boundary structure is provided that includes an annular housing panel and a baffle. The annular housing panel has a first end segment and a second end segment. The first end segment of the housing panel (HPFES) has an HPFES outer radial surface and a HPFES support rail extending radially outward from the HPFES outer radial surface. The baffle has a body and a first stiffening ring. The body has a baffle first end segment and a baffle second end segment. The first stiffening ring is attached to an inner radial surface of the baffle first end segment. The first stiffening ring has an edge surface. The baffle is engaged with the annular housing panel such that the baffle first end segment is in contact with the HPFES support rail. The edge surface of the first stiffening ring is radially aligned with the HPFES support rail.

In any of the aspects or embodiments described above and herein, the first end segment of the housing panel may be disposed at a forward end of the housing panel.

In any of the aspects or embodiments described above and herein, the baffle first end segment (BFES) may have a BFES inner radial surface, and the BFES inner radial surface may be in contact with the HPFES support rail.

In any of the aspects or embodiments described above and herein, the baffle first end segment may have a BFES thickness, and the first stiffening ring may have a thickness, and the thickness of the first stiffening ring may be equal to the BFES thickness.

In any of the aspects or embodiments described above and herein, the baffle first end segment may have a BFES thickness, and the first stiffening ring may have a thickness, and the thickness of the first stiffening ring may be greater than the BFES thickness.

In any of the aspects or embodiments described above and herein, the first end segment of the housing panel may include a HPFES bumper, and the baffle first end segment may include a BFES edge surface, and the BFES edge surface may be radially aligned with the HPFES bumper.

In any of the aspects or embodiments described above and herein, the second end segment of the housing panel may be disposed at an aft end of the housing panel, and the second end segment of the housing panel (HPSES) may have an HPSES outer radial surface, and a HPSES support rail extending radially outward from the HPSES outer radial surface, and wherein the baffle may be engaged with the annular housing panel such that the baffle second end segment is in contact with the HPSES support rail.

In any of the aspects or embodiments described above and herein, the baffle second end segment (BSES) may have a BSES inner radial surface, and the BSES inner radial surface may be in contact with the HPSES support rail.

In any of the aspects or embodiments described above and herein, the second end segment of the housing panel may include a HPSES bumper, and the baffle second end segment may include a BSES edge surface, and the BSES edge surface may be radially aligned with the HPSES bumper.

In any of the aspects or embodiments described above and herein, the first end segment of the housing panel may be disposed at an aft end of the housing panel.

In any of the aspects or embodiments described above and herein, the baffle first end segment (BFES) may have a BFES inner radial surface, and the BFES inner radial surface may be in contact with the HPFES support rail.

In any of the aspects or embodiments described above and herein, the first end segment of the housing panel may include a HPFES bumper, and the baffle first end segment may include a BFES edge surface, and the BFES edge surface may be radially aligned with the HPFES bumper.

In any of the aspects or embodiments described above and herein, the baffle first end segment may have a BFES thickness, and the first stiffening ring may have a thickness, and the thickness of the first stiffening ring may be greater than the BFES thickness.

In any of the aspects or embodiments described above and herein, the second end segment of the housing panel (HPSES) may have an HPSES outer radial surface and a HPSES support rail extending radially outward from the HPSES outer radial surface, and the baffle may be engaged with the housing panel such that the baffle second end segment is in contact with the HPSES support rail.

In any of the aspects or embodiments described above and herein, the baffle second end segment (BSES) may include a BSES inner radial surface, and the baffle may further include a second stiffening ring attached to the BSES inner radial surface.

In any of the aspects or embodiments described above and herein, the second stiffening ring may include a second edge surface and the second edge surface may be radially aligned with the HPSES support rail.

In any of the aspects or embodiments described above and herein, the first stiffening ring may be disposed to limit axial travel of the baffle relative to the housing panel in a first axial direction, and the second stiffening ring may be disposed to limit axial travel of the baffle relative to the housing panel in a second axial direction, wherein the first axial travel direction is opposite the second axial travel direction.

In any of the aspects or embodiments described above and herein, the baffle second end segment may have a BSES thickness, and the second stiffening ring may have a thickness, and the thickness of the second stiffening ring may be greater than the BSES thickness.

In any of the aspects or embodiments described above and herein, the baffle may be engaged with the annular housing panel by a interference fit.

According to an aspect of the present disclosure, a core gas path boundary structure is provided that includes an annular housing panel and a baffle. The annular housing panel has a first end segment and a second end segment. The first end segment of the housing panel (HPFES) has an HPFES outer radial surface and a HPFES support rail extending radially outward from the HPFES outer radial surface. The second end segment of the housing panel (HPSES) has an HPSES outer radial surface and a HPSES support rail extending radially outward from the HPSES outer radial surface. The baffle has a body, a first stiffening ring, and a second stiffening ring, wherein the body has a baffle first end segment and a baffle second end segment. The first stiffening ring is attached to an inner radial surface of the baffle first end segment. The second stiffening ring is attached to an inner radial surface of the baffle second end segment. The baffle is engaged with the annular housing panel such that the baffle first end segment is in contact with the HPFES support rail, and the baffle second end segment is in contact with the HPSES support rail. The first stiffening ring is radially aligned with the HPFES support rail and the second stiffening ring is radially aligned with the HPSES support rail.

The foregoing features and elements may be combined in various combinations without exclusivity, unless expressly indicated otherwise. For example, aspects and/or embodiments of the present disclosure may include any one or more of the individual features or elements disclosed above and/or below alone or in any combination thereof. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a diagrammatic view of a gas turbine engine.

FIG. 2 is a diagrammatic illustration of a portion of a gas turbine engine.

FIG. 3 is a diagrammatic perspective view of a portion of an annular housing panel and an annular baffle embodiment.

FIG. 4 is a diagrammatic sectional view of a core gas path boundary structure, including the annular housing panel and annular baffle shown in FIG. 3.

FIG. 5 is a diagrammatic sectional view of the annular housing panel embodiment.

FIG. 6 is a diagrammatic sectional view of the annular baffle embodiment.

FIG. 7 is a diagrammatic sectional view of a stiffening ring embodiment.

FIG. 8 is a diagrammatic sectional view of a core gas path boundary structure embodiment.

FIG. 9 is a diagrammatic sectional view of a core gas path boundary structure embodiment.

FIG. 10 is a diagrammatic sectional view of a core gas path boundary structure embodiment.

FIG. 11 is a diagrammatic view of an anti-rotation element embodiment.

### DETAILED DESCRIPTION

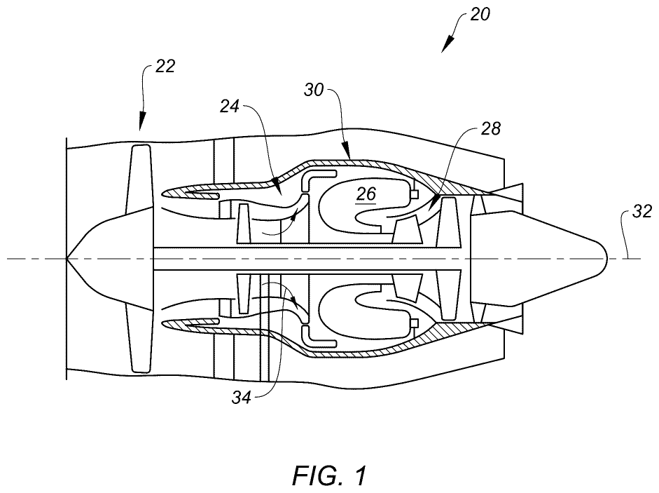

FIG. 1 is a diagrammatic illustration of a gas turbine engine 20 that includes the fan section 22, a compressor section 24, a combustor 26, a turbine section 28, an engine casing 30, and a central axis 32. The engine casing 30 surrounds portions of the compressor section 24, the combustor 26, and the turbine section 28. A core gas path 34 extends through the compressor section 24, the combustor 26, and the turbine section 28. The gas turbine engine 20 shown in FIG. 1 is provided to facilitate the description of the present disclosure. The present disclosure is not limited to any particular gas turbine engine configuration other than as is described herein.

The terms “forward”, “leading”, “aft, “trailing” are used herein to indicate the relative position of a component or surface. As core gas air passes through the engine 20, a “leading edge” of a stator vane or rotor blade encounters core gas air before the “trailing edge” of the same. In an engine 20 like that shown in FIG. 1, the fan section 22 is “forward” of the compressor section 24 and the turbine section 28 is “aft” of the compressor section 24. The terms “upstream” and “downstream” used herein refer to the direction of an air/gas flow passing through the core gas path of the turbine engine 20. The terms “radial” and “circumferential” are used herein with respect to the central axis 32 of the turbine engine 20.

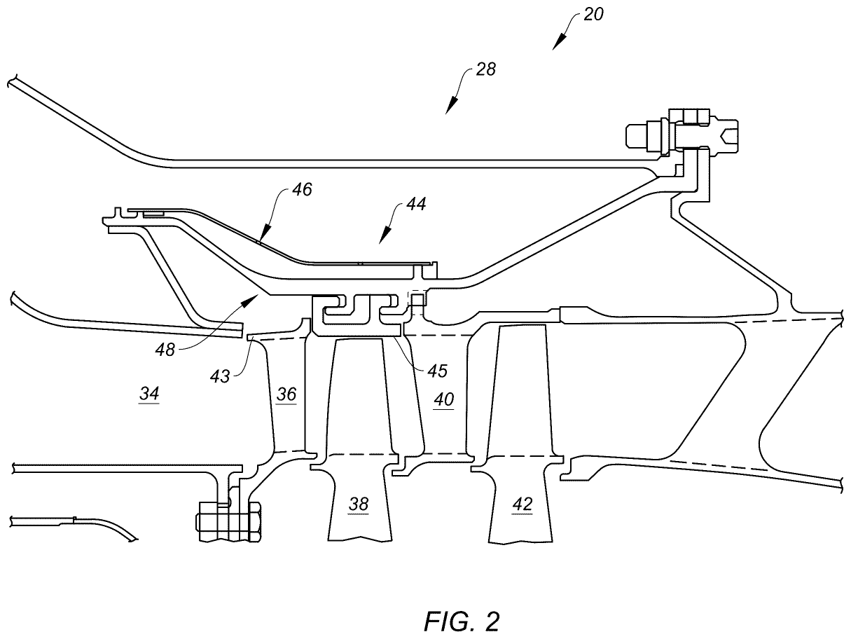

FIG. 2 is a diagrammatic illustration of a portion of the turbine section 28 of a gas turbine engine 20 including a turbine inlet guide vane stage 36, a turbine first rotor stage 38, a second turbine vane stage 40, and a turbine second rotor stage 42. The core gas path 34 extends through the turbine inlet guide vane stage 36 and thereafter passes through the remainder of the turbine section 28 before exiting the gas turbine engine 20. The outer radial platforms 43 of the turbine inlet guide vane stage 36, the blade outer air seal 43 for the turbine first rotor stage 38, and other components (collectively referred to as the “core gas path boundary structure 44”) collectively define the outer radial boundary of the core gas path 34 in this region of the turbine section 28. In the embodiment shown in FIG. 2, an outer core gas path boundary structure 44 is shown having an annular baffle 46 and an annular housing panel 48. The baffle 46 is disposed radially outside of the housing panel 48. This outer core gas path boundary structure 44 is an example of a structure that may be configured according to the present disclosure.

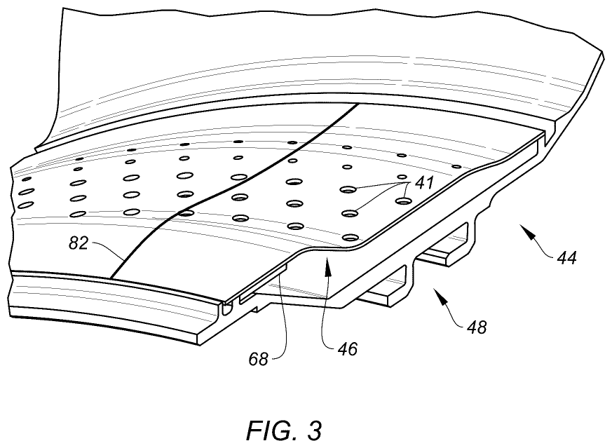

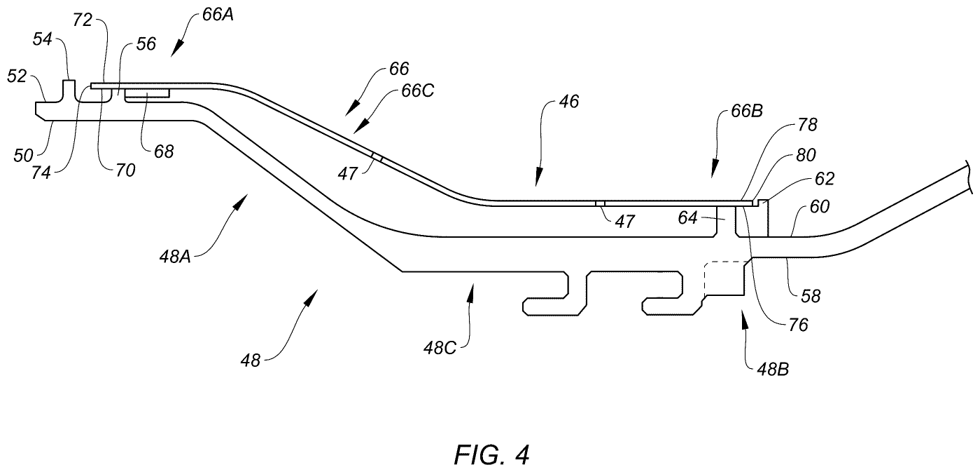

FIG. 3 is a perspective view of a portion of a core gas path boundary structure configured according to the present disclosure. In this instance, the core gas boundary structure is disposed as an outer core gas boundary structure 44. To facilitate the description herein, the present disclosure will be described in terms of an outer core path boundary structure 44 but is not limited to any particular core gas path boundary application. The outer core gas path boundary structure 44 includes an annular housing panel 48 and an annular baffle 46. FIG. 4 is a planar sectional view of the annular housing panel 48 and annular baffle 46 shown in FIG. 3.

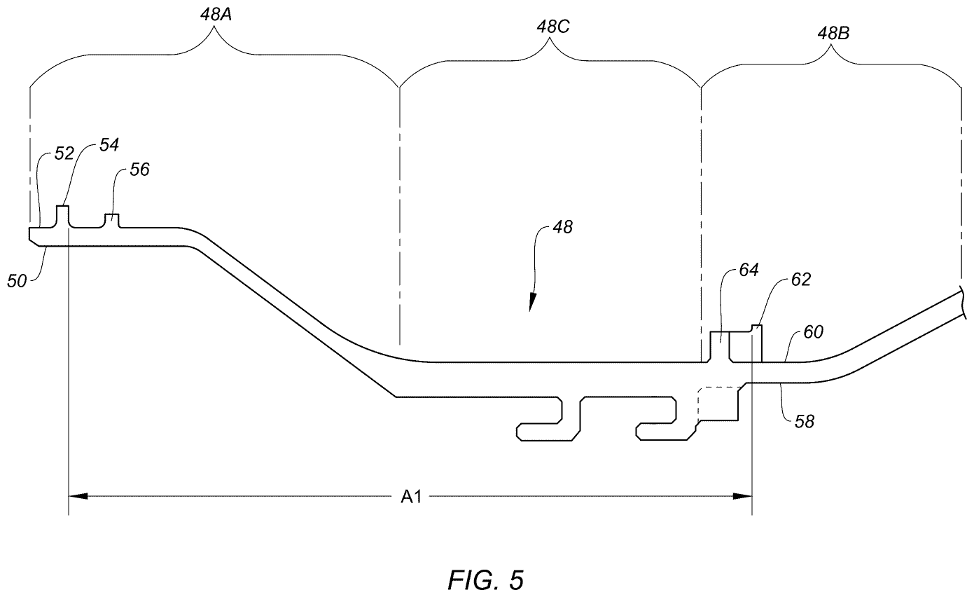

Referring to FIGS. 4 and 5, the housing panel 48 is an annular structure that includes a forward segment 48A, an aft segment 48B, and a center segment 48C in communication with the forward segment 48A and the aft segment 48B. In the embodiment shown in FIGS. 4 and 5, the forward segment 48A includes an inner radial surface 50, an outer radial surface 52, a forward bumper 54, and a forward support rail 56. The forward bumper 54 and the forward support rail 56 extend radially outward from the outer radial surface 52 of the forward segment 48A. The aft segment 48B includes an inner radial surface 58, an outer radial surface 60, an aft bumper 62, and an aft support rail 64. The aft bumper 62 and the aft support rail 64 extend radially outward from the outer radial surface 60 of the aft segment 48B. The forward bumper 54 and the aft bumper 62 are separated from one another by an axial distance “A1”—see FIG. 5. The housing panel 48 may be a unitary structure or may include a plurality of circumferential segments that are attached to one another to collectively arrive at the annular housing panel 48. The above described example of an annular housing panel 48 is an example of a housing panel 48 with which the annular baffle 46 may be used and the present disclosure is not limited thereto.

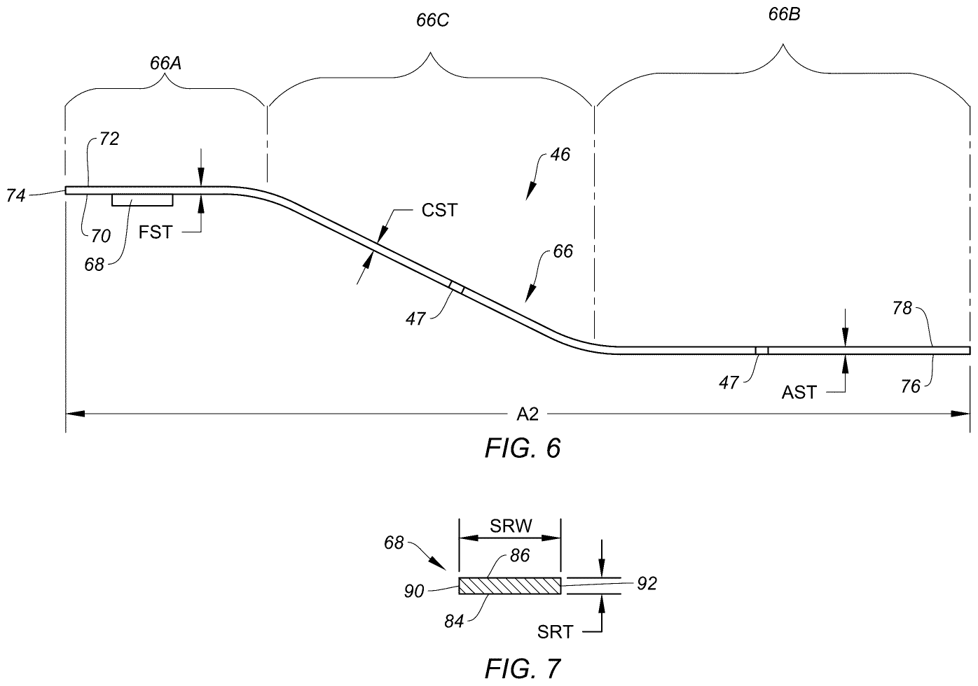

Referring to FIGS. 4 and 6, the baffle 46 is an annular structure that includes a body 66 with a forward segment 66A, an aft segment 66B, a center segment 66C in communication with the forward segment 66A and the aft segment 66B, and a stiffening ring 68. In the embodiment shown in FIGS. 4 and 6, the forward segment 66A includes an inner radial surface 70, an outer radial surface 72, and a forward edge surface 74. The forward edge surface 74 extends between the inner and outer radial surfaces 70, 72 of the forward segment 66A. The aft segment 66B includes an inner radial surface 76, an outer radial surface 78, and an aft edge surface 80. The aft edge surface 80 extends between the inner and outer radial surfaces 76, 78 of the aft segment 66B. The baffle 46 has an axial length (“A2”) that extends between the forward edge surface 74 and the aft edge surface 80—see FIG. 6. The axial length surface of the baffle 46 (“A2”) may be less than the axial distance (“A1”) between the forward and aft bumpers 54, 62 of the housing panel 48 (i.e., A1>A2) to allow for differences in thermal growth between the baffle 46 and the housing panel 48. The center segment 66C is disposed between and is in communication with the forward segment 66A and the aft segment 66B. The center segment 66C may include a plurality of apertures 47. Each segment 66A, 66B, 66C of the baffle 46 has a thickness that extends between the inner and outer radial surfaces of the respective segment; e.g., the forward segment 66A has a thickness “FST”, the center segment 66C has a thickness “CST”, and the aft segment 66B has a thickness “AST”—see FIG. 6. The baffle 46 may be a unitary structure or may include a plurality of circumferential segments that are attached to one another to collectively arrive at the annular baffle 46. Referring to FIG. 3, in some embodiments the baffle 46 is a unitary structure in the form of a split ring having circumferential ends that may be attached to one another (e.g., by weldment 82—see FIG. 3) to form a continuous annular baffle 46. The baffle 46 may be formed from a thin sheet of metallic material. The present disclosure is not limited to a baffle 46 comprising any particular type of metallic material. In some embodiments, the forward, aft and center segments 66A, 66B, 66C may have the same thickness; e.g., FST=CST=AST. In some embodiments, one or more of the forward, aft and center segments 66A, 66B, 66C may have a thickness that is different from the thickness of another segment.

The stiffening ring 68 may be formed from a thin sheet of metallic material. The present disclosure is not limited to a stiffening ring 68 comprising any particular type of metallic material. The examples of the stiffening rings 68 diagrammatically shown in FIGS. 4 and 7-10 have a rectangular cross-sectional geometry defined by an inner radial surface 84, an outer radial surface 86, a forward edge surface 88, and an aft edge surface 90 (see FIG. 7). The forward and aft edge surfaces 88, 90 extend between the inner and outer radial surfaces 84. 86. Referring to FIG. 7, the stiffening ring 68 has a thickness (“SRT”) that extends between the inner and outer radial surfaces 84, 86 and a width (“SRW”) that extends between the forward and aft edge surfaces 88,90. The present disclosure is not limited to a stiffening ring 68 having a rectangular cross-sectional surface; e.g., the stiffening ring 68 may not have a uniform thickness. In some embodiments, the stiffening ring 68 may have a thickness that is equal to or greater than the thickness of the housing panel segment 48A, 48B to which the stiffening ring 68 is attached. The stiffening ring 68 material may be any metallic material having properties that are acceptable for the application at hand.

In the embodiment shown in FIGS. 4 and 6, the stiffening ring 68 is engaged with (e.g., attached to) the inner radial surface 70 of the baffle forward segment 66A. The stiffening ring 68 may be attached to the baffle body 66 by weldment, mechanical fastener, or the like. The present disclosure is not limited to any mechanism for attaching the stiffening ring 68 to the baffle body 66.

Referring to FIG. 4, in assembled form the inner radial surface 84 of the forward segment 66A of the baffle 46 is in contact with the forward support rail 56 of the housing panel 48. The forward bumper 54 may be described as being radially aligned with the forward edge surface 74 of the baffle forward segment. Consequently, sufficient forward travel of the baffle 46 may cause the forward edge surface 74 of the baffle 46 to contact the forward bumper 54. Hence, the forward bumper 54 is disposed to limit axial travel of the baffle 46 in the forward direction. Also in assembled form, the stiffening ring 68 may be described as being radially aligned with the forward support rail 56. The radial alignment between the stiffening ring 68 and the forward support rail 56 is such that the stiffening ring 68 will contact the forward support rail 56 if the baffle 46 is axially shifted sufficiently (and such movement is not prevented by the forward bumper 54). The inner radial surface 76 of the aft segment 66B of the baffle 46 is in contact with the aft support rail 64 of the housing panel 48. The aft bumper 62 may be described as being radially aligned with the aft edge surface 80 of the baffle aft segment 66B. Consequently, sufficient aft travel of the baffle 46 may cause the aft edge surface 80 of the baffle 46 to contact the aft bumper 62. Hence, the aft bumper 62 is disposed to limit axial travel of the baffle 46 in the aft direction, and in this embodiment, the forward and aft bumpers 54, 62 may be configured to limit forward and aft axial travel of the baffle 46. The baffle 46 may form a slight interference fit with the housing panel 48.

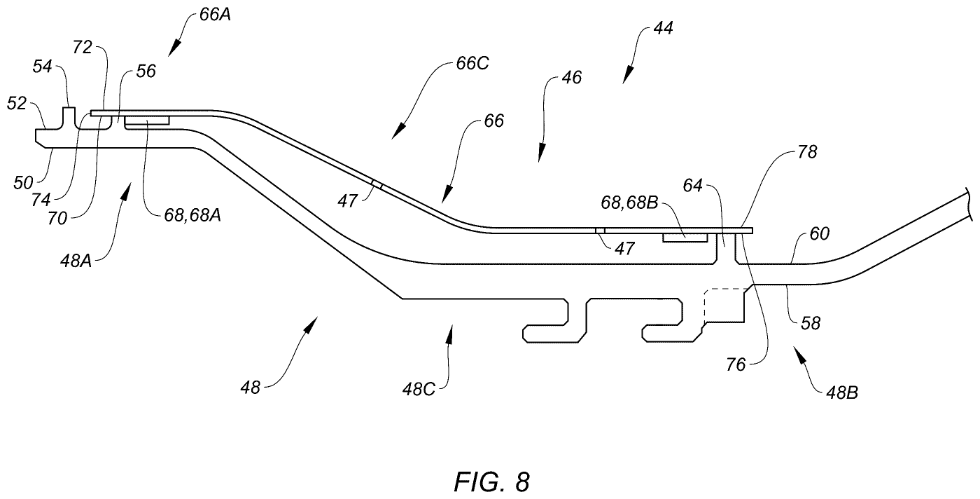

FIG. 8 diagrammatically illustrates an alternative outer core gas path boundary structure 44 embodiment. In this embodiment, the outer core gas path boundary structure 44 includes a housing panel 48 like that shown in FIG. 4 and described above. This embodiment also includes a stiffening ring 68 (referred to in this embodiment as a first stiffening ring 68A) like that shown in FIG. 4 and described above and a second stiffening ring 68B engaged with (e.g., attached to) the inner radial surface 76 of the aft segment 66B. The first and second stiffening rings 68A, 68B may have the same configuration, or they may have different configurations. In this embodiment, the first stiffening ring 68 may be described as being radially aligned with the forward support rail 56 and the second stiffening ring 68 may be described as being radially aligned with the aft support rail 64. The radial alignment between the first stiffening ring 68A and the forward support rail 56 is such that the first stiffening ring 68A will contact the forward support rail 56 if the baffle 46 is axially shifted sufficiently in a forward direction (and such movement is not prevented by the forward bumper 54), and the radial alignment between the second stiffening ring 68B and the aft support rail 64 is such that the second stiffening ring 68 will contact the aft support rail 64 if the baffle 46 is axially shifted sufficiently in an aft direction.

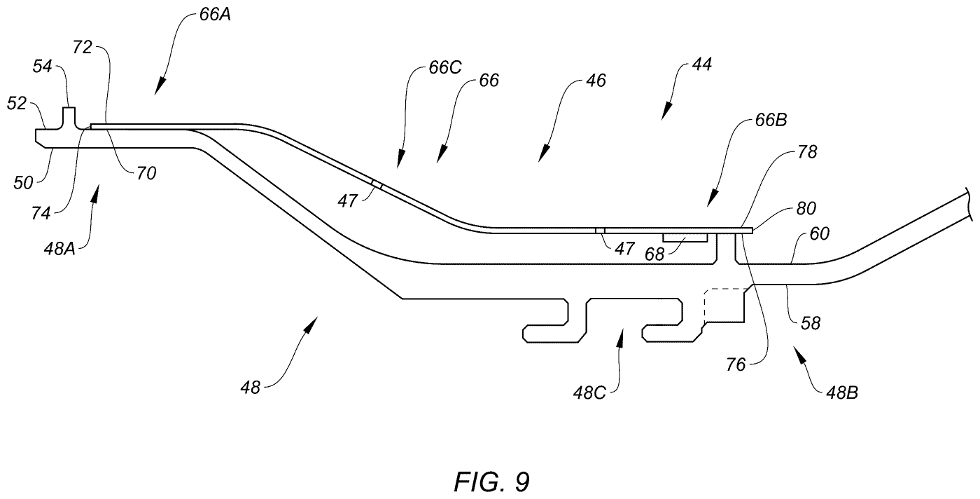

FIG. 9 diagrammatically illustrates an alternative outer core gas path boundary structure 44 embodiment. In this embodiment, the housing panel 48 is like that shown in FIG. 4 and described above with the exception that the housing panel 48 does not include a forward support rail 56 (therefore not shown), and the stiffening ring 68 is engaged with (e.g., attached to) the inner radial surface 76 of the aft segment 66C. In this embodiment, the stiffening ring 68 may be described as being radially aligned with the aft support rail 64. The radial alignment between the stiffening ring 68 and the aft support rail 64 is such that the stiffening ring 68 will contact the aft support rail 64 if the baffle 46 is axially shifted sufficiently in an aft direction.

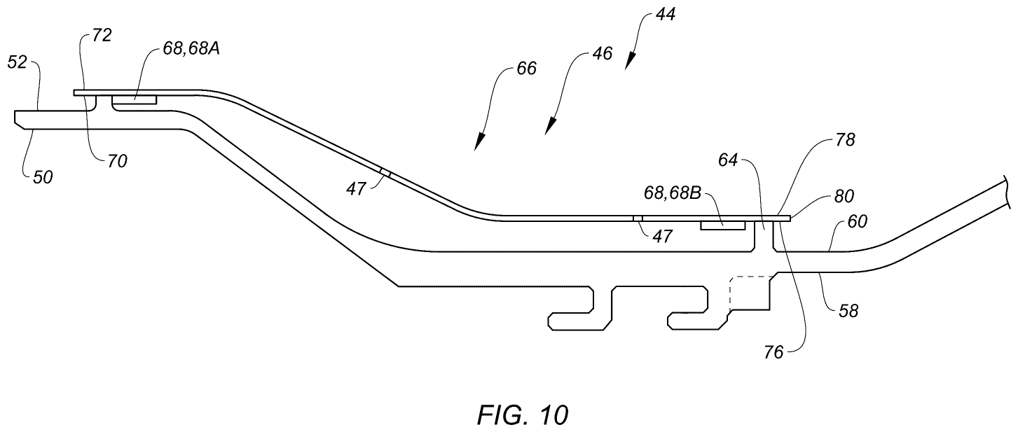

FIG. 10 diagrammatically illustrates an alternative outer core gas path boundary structure 44 embodiment. In this embodiment, the housing panel 48 includes forward and aft support rails 56, 64 and does not include a forward bumper 54 (not shown) or an aft bumper 62 (not shown). In this embodiment, the baffle 46 includes first and second stiffening rings 68A, 68B. Present disclosure housing panel 48 embodiments may include a forward bumper 54 and no aft bumper 62, or conversely an aft bumper 62 and no forward bumper 54. In these embodiments, the forward and aft support rails 56, 64 may operate to limit axial movement of the baffle 46 rather than a respective bumper 54, 62 limiting axial movement.

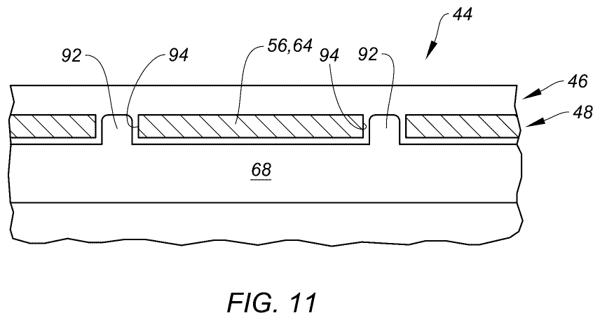

Referring to FIG. 11, in some embodiments, the outer core gas path boundary structure 44 may be configured to prevent circumferential rotational travel relative to the housing panel 48. For example, a stiffening ring 68 (i.e., any of the stiffening ring 68 embodiments described herein) may include one or more male features 92 that are received within mating female features 94 disposed in a support rail 56, 64 (i.e., any of the support rail embodiments described herein). The anti-rotation elements 92, 94 shown in FIG. 11 (i.e., the mating male and female features) are non-limiting examples of anti-rotation features and the present disclosure is not limited thereto.

During operation of a gas turbine engine 20 including a present disclosure outer core gas path boundary structure 44, the baffle 46 is configured to create a desirable heat transfer environment relative to the housing panel 48; e.g., cooling air passing through the apertures 47 within the baffle 46 create impingement cooling of the housing panel 48.

As indicated herein, the baffle 46 may be disposed to be in contact with the housing panel 48 (e.g., in contact with the forward and aft support rails 56, 64) in a slight interference fit. When the interference fit exists, the interference fit operates to maintain the relative axial positions between the baffle 46 and the housing panel 48. However, during operation of the gas turbine engine 20, thermal growth disparities between the baffle 46 and the housing panel 48 can decrease or eliminate the interference fit. As a result, loading on the baffle 46 (e.g., operational loads, differences in pressure across the baffle 46, and the like) may subject the baffle 46 to undesirable axial movement. Repeated contact between the forward and/or aft edge surfaces 74,80 of the baffle 46 and an element of the housing panel 48 (e.g., a bumper 54,62) can wear and/or damage the baffle 46 (and/or the housing panel 48) and thereby negatively affect the useful life of the baffle 46 (and/or the housing panel 48). Moreover, regions of the baffle 46 (e.g., portions of the forward segment 66A and/or portions of the aft segment 66B) may exhibit edge-wise bending modes. Induced vibratory stresses in these baffle portions can also reduce the useful life of the baffle 46.

The present disclosure provides a novel and unobvious solution that decreases or eliminates the shortcomings of prior art baffles. As indicated above, a stiffening ring 68 may be attached to the forward segment 66A of the baffle 46 proximate the forward edge surface 74 of the forward segment 66A, or attached to the aft segment 66B of the baffle 46 proximate the aft edge surface 80 of the aft segment 66B, or both. The stiffening ring 68 provides several advantages. For example, in those embodiments wherein the stiffening ring 68 is disposed to limit axial travel of the baffle 46, the stiffening ring 68 is disposed to contact a feature of the housing panel 48 (e.g., the respective support rail 56,64) and thereby obviate contact between the respective edge surface 74, 80 of the baffle 46 and the housing panel 48. In those embodiments wherein the stiffening ring 68 has a thickness greater than the thickness of the baffle 46, the increased contact surface area of stiffening ring 68 (relative to the contact area of the edge surface 74,80 of the baffle 46) is understood to reduce contact stress and thereby increase the durability of the baffle 46. The stiffening ring 68 provides this benefit with less additional weight in contrast with a thicker baffle body. The stiffening ring 68 also increases the stiffness of the baffle body segment 66A,66B to which it is attached (e.g., the forward segment 66A or the aft segment 66B). The increased stiffness is understood to mitigate vibratory mode response by the respective baffle segment 66A,66B and thereby improve the durability of the baffle 46. Embodiments of the present disclosure (e.g., as shown in FIG. 10) may also provide baffle 46 axial movement limits without the need to include bumpers 54, 62 extending outwardly from the housing panel 48, thereby resulting in a weight savings.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements. It is further noted that various method or process steps for embodiments of the present disclosure are described herein. The description may present method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

1. A core gas path boundary structure, comprising:
an annular housing panel extending axially between a first end segment and a second end segment, the first end segment of the housing panel (HPFES) having an HPFES outer radial surface, and a HPFES support rail extending radially outward from the HPFES outer radial surface;
a baffle having a body and a first stiffening ring, the body having a baffle first end segment and a baffle second end segment, wherein the first stiffening ring is attached to an inner radial surface of the baffle first end segment, and the first stiffening ring has an edge surface;
wherein the baffle is engaged with the annular housing panel such that the baffle first end segment is in contact with the HPFES support rail; and
wherein the edge surface of the first stiffening ring is radially aligned with the HPFES support rail, the first stiffening ring is axially adjacent to the HPFES support rail, and the first stiffening ring is disposed axially between the HPFES support rail and the second end segment.

2. The core gas path boundary structure of claim 1, wherein the first end segment of the housing panel is disposed at a forward end of the housing panel.

3. The core gas path boundary structure of claim 2, wherein the baffle first end segment (BFES) has a BFES inner radial surface, and the BFES inner radial surface is in contact with the HPFES support rail.

4. The core gas path boundary structure of claim 3, wherein the baffle first end segment has a BFES thickness, and the first stiffening ring has a thickness, and the thickness of the first stiffening ring is equal to the BFES thickness.

5. The core gas path boundary structure of claim 3, wherein the baffle first end segment has a BFES thickness, and the first stiffening ring has a thickness, and the thickness of the first stiffening ring is greater than the BFES thickness.

6. The core gas path boundary structure of claim 5, wherein the first end segment of the housing panel includes a HPFES bumper; and
wherein the baffle first end segment includes a BFES edge surface; and
wherein the BFES edge surface is radially aligned with the HPFES bumper.

7. The core gas path boundary structure of claim 2, wherein the second end segment of the housing panel is disposed at an aft end of the housing panel; and
wherein the second end segment of the housing panel (HPSES) has an HPSES outer radial surface, and a HPSES support rail extending radially outward from the HPSES outer radial surface, and wherein the baffle is engaged with the annular housing panel such that the baffle second end segment is in contact with the HPSES support rail.

8. The core gas path boundary structure of claim 7, wherein the baffle second end segment (BSES) has a BSES inner radial surface, and the BSES inner radial surface is in contact with the HPSES support rail.

9. The core gas path boundary structure of claim 8, wherein the second end segment of the housing panel includes a HPSES bumper; and
wherein the baffle second end segment includes a BSES edge surface; and
wherein the BSES edge surface is radially aligned with the HPSES bumper.

10. The core gas path boundary structure of claim 1, wherein the first end segment of the housing panel is disposed at an aft end of the housing panel.

11. The core gas path boundary structure of claim 10, wherein the baffle first end segment (BFES) has a BFES inner radial surface, and the BFES inner radial surface is in contact with the HPFES support rail.

12. The core gas path boundary structure of claim 11, wherein the first end segment of the housing panel includes a HPFES bumper; and
wherein the baffle first end segment includes a BFES edge surface; and
wherein the BFES edge surface is radially aligned with the HPFES bumper.

13. The core gas path boundary structure of claim 1, wherein the baffle first end segment has a BFES thickness, and the first stiffening ring has a thickness, and the thickness of the first stiffening ring is greater than the BFES thickness.

14. The core gas path boundary structure of claim 1, wherein the second end segment of the housing panel (HPSES) has an HPSES outer radial surface and a HPSES support rail extending radially outward from the HPSES outer radial surface; and
wherein the baffle is engaged with the housing panel such that the baffle second end segment is in contact with the HPSES support rail.

15. The core gas path boundary structure of claim 14, wherein the baffle second end segment (BSES) includes a BSES inner radial surface; and
wherein the baffle further comprises a second stiffening ring attached to the BSES inner radial surface.

16. The core gas path boundary structure of claim 15, wherein the second stiffening ring includes a second edge surface and the second edge surface is radially aligned with the HPSES support rail.

17. The core gas path boundary structure of claim 16, wherein the first stiffening ring is disposed to limit axial travel of the baffle relative to the housing panel in a first axial direction, and the second stiffening ring is disposed to limit axial travel of the baffle relative to the housing panel in a second axial direction, wherein the first axial travel direction is opposite the second axial travel direction.

18. The core gas path boundary structure of claim 17, wherein the baffle second end segment has a BSES thickness, and the second stiffening ring has a thickness, and the thickness of the second stiffening ring is greater than the BSES thickness.

19. (canceled)

20. A core gas path boundary structure, comprising:
an annular housing panel extending axially between a first end segment and a second end segment, the first end segment of the housing panel (HPFES) having an HPFES outer radial surface and a HPFES support rail extending radially outward from the HPFES outer radial surface, and the second end segment of the housing panel (HPSES) having an HPSES outer radial surface and a HPSES support rail extending radially outward from the HPSES outer radial surface;
a baffle having a body, a first stiffening ring, and a second stiffening ring, wherein the body has a baffle first end segment and a baffle second end segment, wherein the first stiffening ring is attached to an inner radial surface of the baffle first end segment, and wherein the second stiffening ring is attached to an inner radial surface of the baffle second end segment;
wherein the baffle is engaged with the annular housing panel such that the baffle first end segment is in contact with the HPFES support rail, and the baffle second end segment is in contact with the HPSES support rail; and
wherein the first stiffening ring is radially aligned with the HPFES support rail, the second stiffening ring is radially aligned with the HPSES support rail, the first stiffening ring is axially aft of the HPFES support rail, and the first stiffening ring is disposed axially between the HPFES support rail and the HPSES support rail.

21. The core gas boundary structure of claim 20, wherein the second stiffening ring is axially forward to the HPSES support rail and disposed axially between the HPSES support rail and the first stiffening ring.
